(19) United States
(12) Patent Application Publication
(10) Pub. No.: US 2026/0321235 A1
(43) Pub. Date: Oct. 15, 2026

(54) SYSTEMS AND METHODS FOR ACOUSTIC SIGNAL EXTRACTION

(71) Applicant: The Boeing Company, Arlington, VA (US)

(72) Inventors: Qin JIANG, Oak Park, CA (US); Yuri OWECHKO, Newbury Park, CA (US)

(21) Appl. No.: 19/174,203

(22) Filed: Apr. 9, 2025

(51) Int. Cl. G10K 11/16

(52) U.S. Cl. CPC G10K 11/161

(57) ABSTRACT

In some implementations, a system may receive a signal sequence corresponding to sensor data captured by a single sensor. The sensor data may represent a combined signal. The combined signal may include one or more acoustic signals and noise. The system may perform an independent component analysis procedure. The independent component analysis procedure may separate the one or more acoustic signals and the noise.

### FIELD

The present disclosure relates generally to signal processing and to acoustic signal extraction.

### BACKGROUND

Acoustic signal extraction is a process of extracting useful information from acoustic signals. An acoustic signal extraction method may include narrow band filtering, matched filtering, energy detection, fast Fourier transform filtering, and adaptive filtering. For an underwater acoustic signal, a short-time Fourier transform, a wavelet transform, or a Hilbert-Huang transform may be used for acoustic signal extraction.

### SUMMARY

Some implementations described herein relate to a method. The method may include receiving a signal sequence corresponding to sensor data captured by a single sensor, wherein the sensor data represents a combined signal, wherein the combined signal includes one or more acoustic signals and noise. The method may include performing an independent component analysis procedure, wherein the independent component analysis procedure separates the one or more acoustic signals and the noise.

Some implementations described herein relate to a system. The system may include one or more memories and one or more processors coupled to the one or more memories. The one or more processors may be configured to receive a signal sequence corresponding to sensor data captured by a single sensor, wherein the sensor data represents a combined signal, wherein the combined signal includes one or more acoustic signals and noise. The one or more processors may be configured to perform an independent component analysis procedure to separate the one or more acoustic signals and the noise.

Some implementations described herein relate to a non-transitory computer-readable medium that stores a set of instructions. The set of instructions, when executed by one or more processors of a system, may cause the system to receive a signal sequence corresponding to sensor data captured by a single sensor, wherein the sensor data represents a combined signal, wherein the combined signal includes one or more acoustic signals and noise. The set of instructions, when executed by one or more processors of the system, may cause the system to perform an independent component analysis procedure to separate the one or more acoustic signals and the noise.

The features, functions, and advantages that have been discussed can be achieved independently in various implementations or may be combined in yet other implementations further details of which can be seen with reference to the following description and drawings.

### BRIEF DESCRIPTION OF THE DRAWINGS

FIGS. 1A-1I are diagrams of an example implementation associated with acoustic signal extraction.

FIG. 2 is a diagram of an example environment in which systems and/or methods described herein may be implemented.

FIG. 3 is a diagram of example components of a device associated with acoustic signal extraction.

FIGS. 4 and 5 are flowcharts of example processes associated with acoustic signal extraction.

FIG. 6 is a flowchart of an example process associated with performing an independent component analysis.

### DETAILED DESCRIPTION

The following detailed description of example implementations refers to the accompanying drawings. The same reference numbers in different drawings may identify the same or similar elements.

Extracting undersea acoustic signals may be used in various ocean-related applications, such as applications related to underwater autonomous vehicles, ocean surveillance, marine biology research, and anti-submarine warfare. In some cases, propagation loss and ocean noise may cause the acoustic signal to weaken as the signal propagates through the water.

For example, an ocean environment may contain many background sounds, such as ocean current flows, mammal sounds, and fish movement. Additionally, factors such as ocean temperature, depth, and water reverberation, may weaken an acoustic signal and/or otherwise affect acoustic signal propagation under water, which may limit and/or complicate an ability to extract acoustic signals in an undersea environment.

In some cases, an underwater acoustic signal extraction system may use a spectrogram thresholding technique to extract an acoustic signal. However, when a signal-to-noise ratio (SNR) is low (e.g., less than a threshold), a spectrogram thresholding technique may be unable to extract the acoustic signal.

In some cases, a blind-source separation technique may be used to extract an acoustic signal. Commonly, the blind-source separation technique requires inputs from multiple sensors positioned at different geographical locations. However, in some cases, only a single sensor may be available and/or the use of multiple sensors positioned at geographical locations may not be possible.

Some implementations described herein relate to a signal extraction system configured to utilize a single sensor, blind-source separation technique to extract acoustic signals in noisy (e.g., underwater) environments. In some aspects, the signal extraction system that utilizes a sliding window method may be used to extract acoustic signals for achieving real-time computation. In some aspects, the acoustic signals may be extracted in the spectrogram domain and converted into a spectrogram image. In some aspects, a time-frequency shifting method may be applied to generate multiple versions of the spectrogram image. In some aspects, an independent component analysis (ICA) technique may applied to the multiple spectrogram images to separate acoustic signals and noise into different independent components. In some aspects, a deconvolution technique may be used to reduce distortions introduced by the time-frequency shifting process and the ICA process. In some aspects, a set of one or more independent components with acoustic signals of interest may be selected and a signal-size-filtering technique may be used to reduce noise and extract the signals of interest. As a result, an acoustic signal can be extracted from a noisy environment (e.g., an underwater environment) using a single acoustic sensor. Further, the implementations described herein may result in an increased maximal signal detection range.

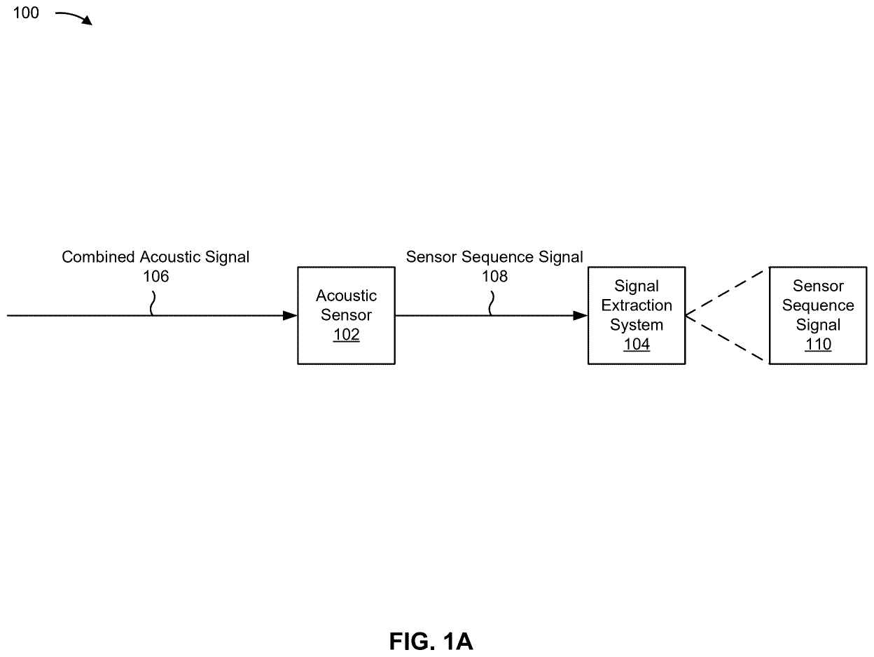

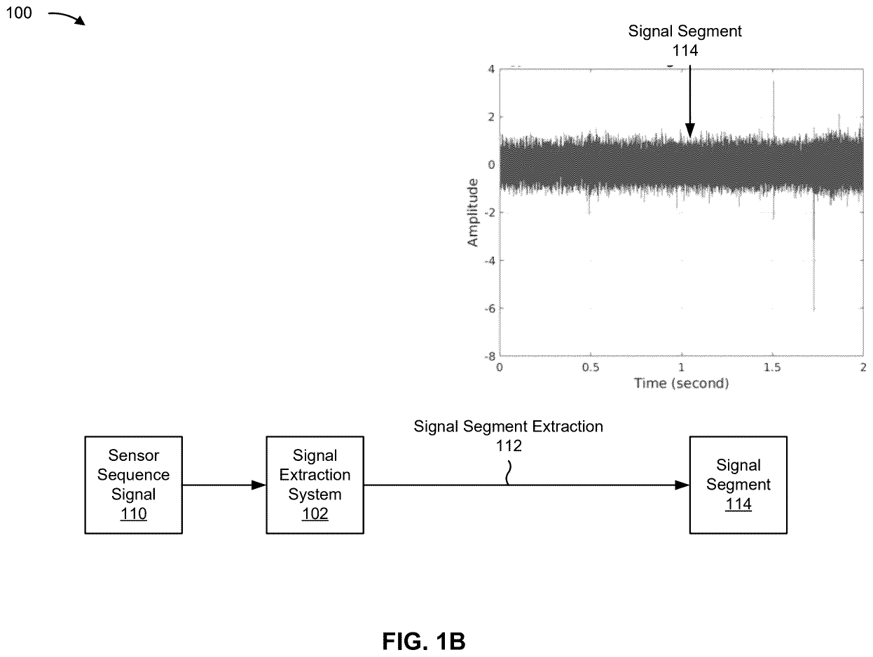

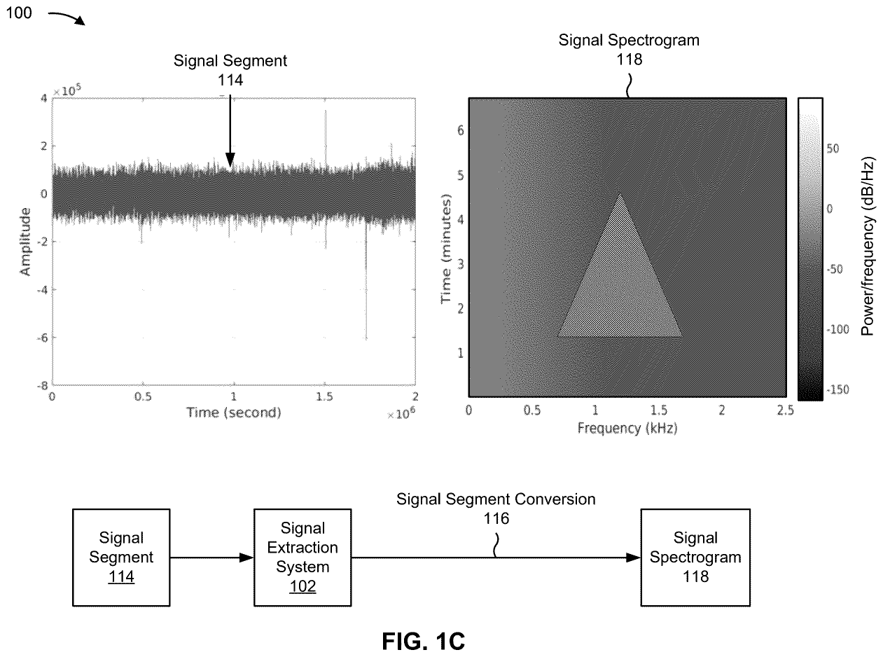

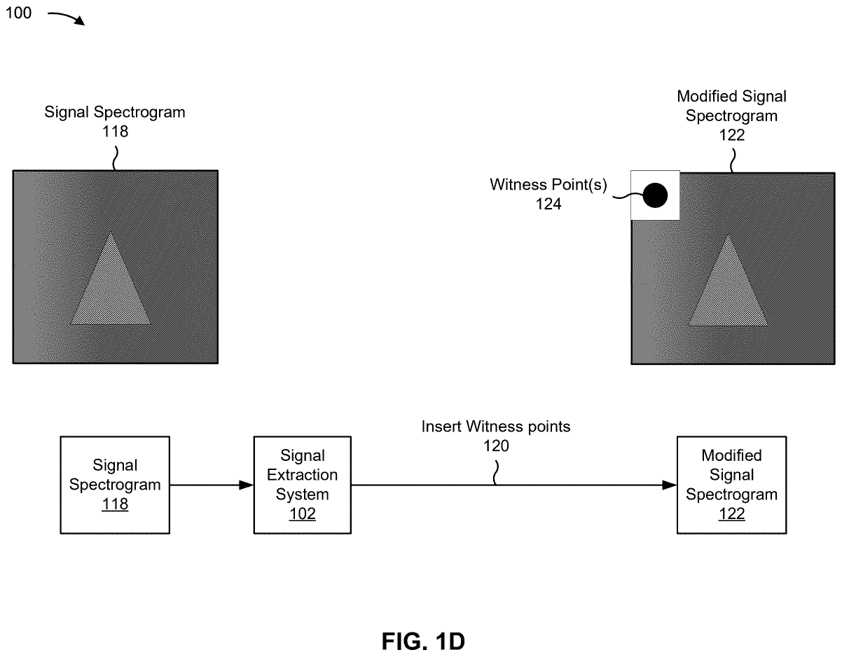

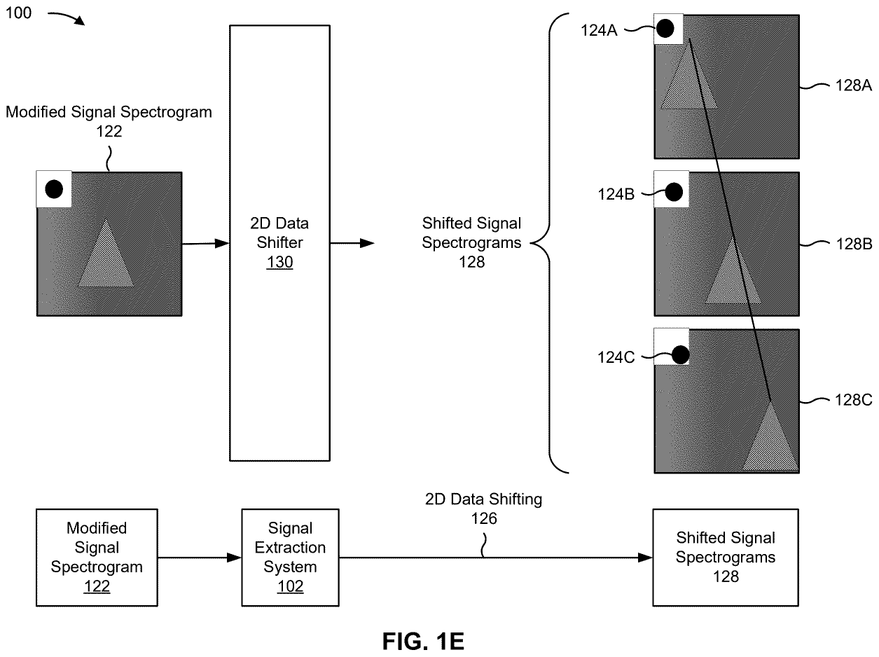

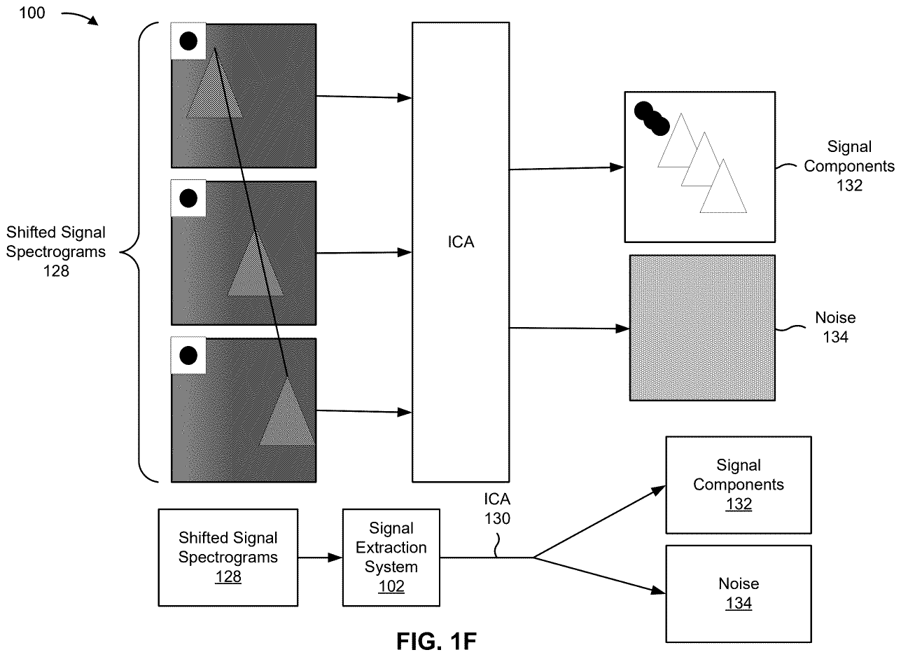

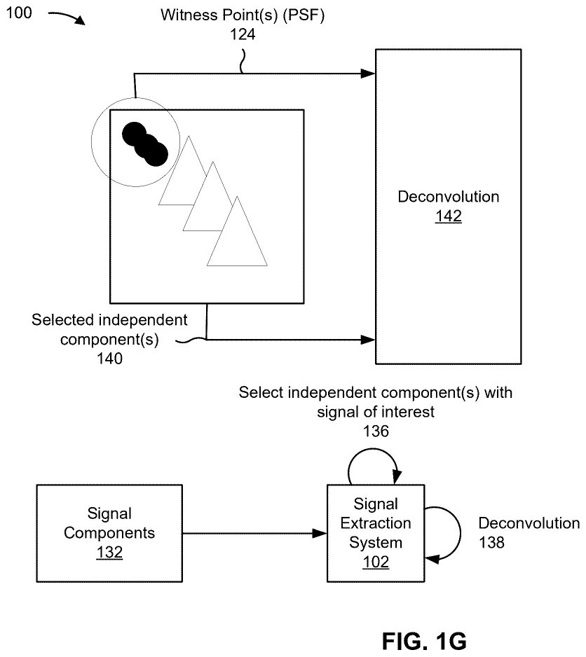

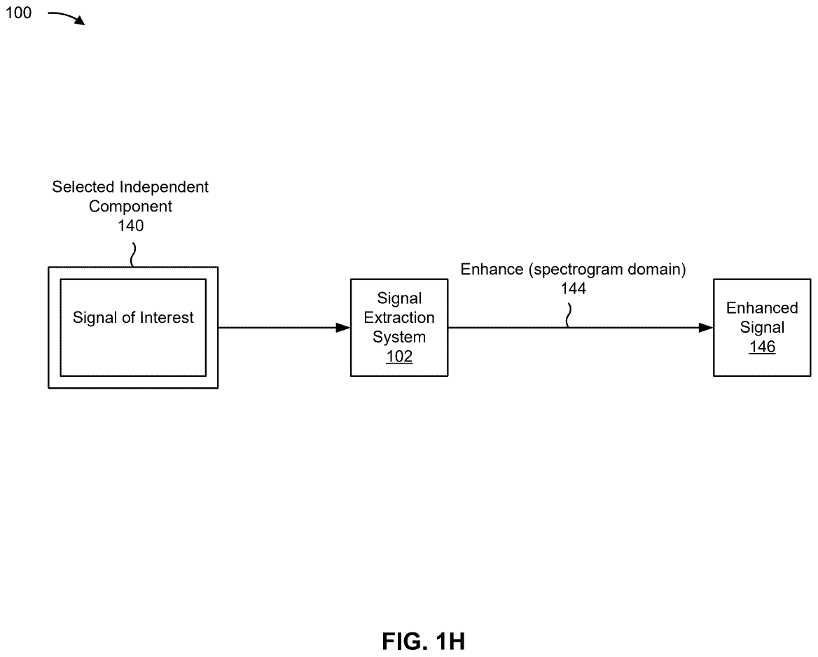

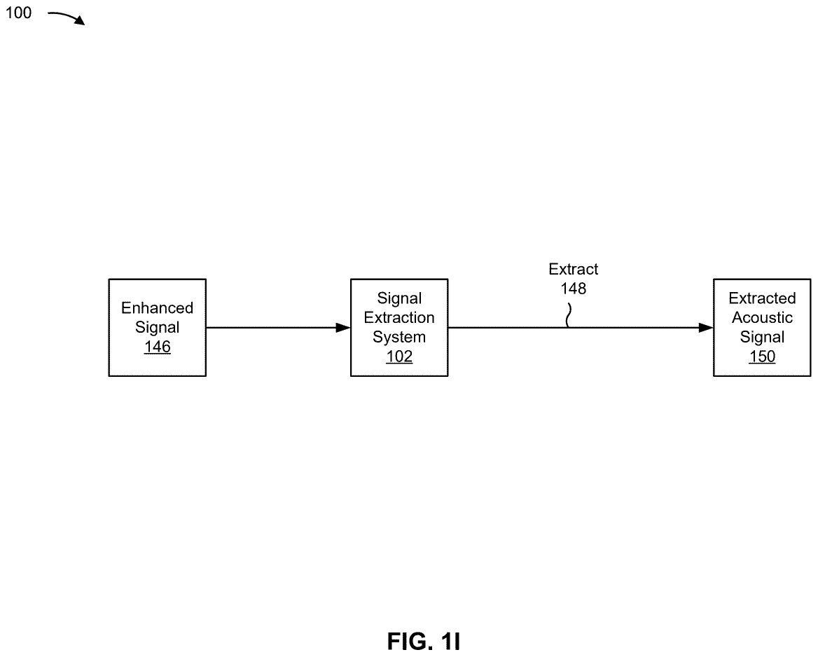

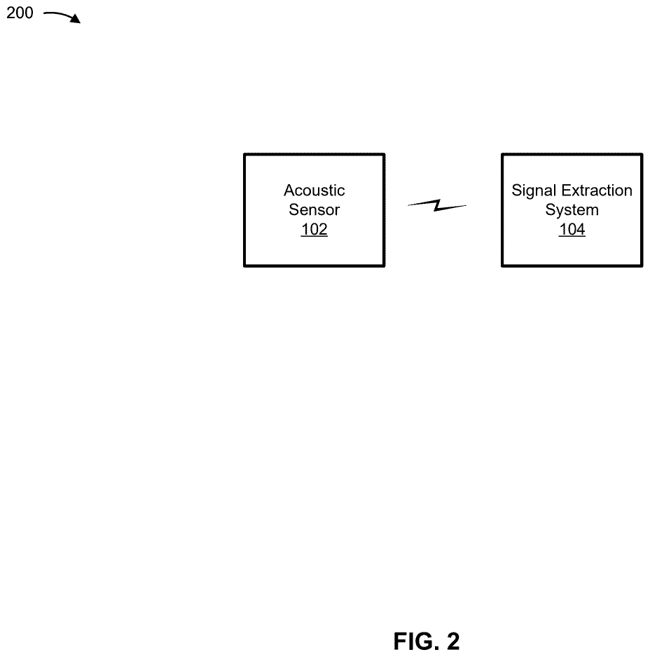

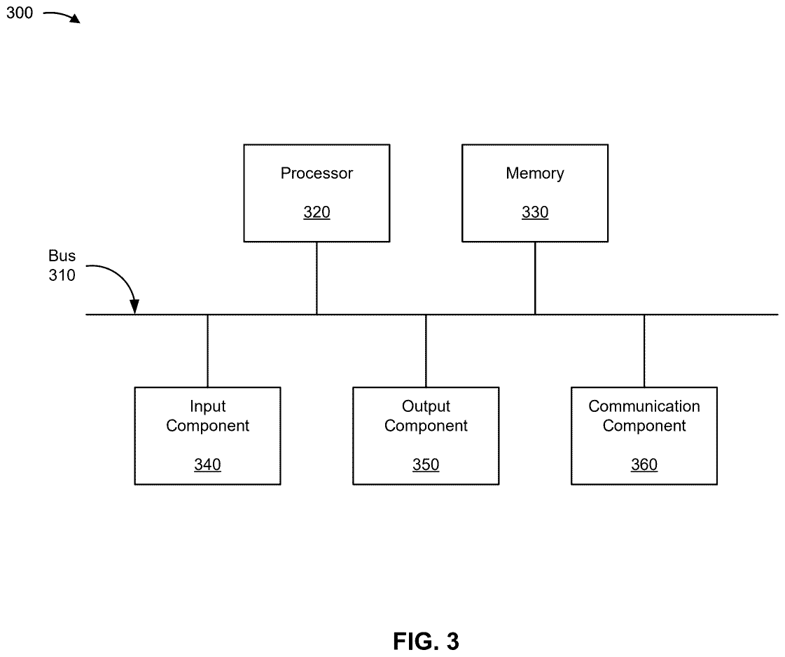

FIGS. 1A-1I are diagrams of an example implementation 100 associated with systems and methods for acoustic signal extraction. As shown in FIGS. 1A-1I, example implementation 100 includes an acoustic sensor 102 and a signal extraction system 104. These devices are described in more detail below in connection with FIG. 2 and FIG. 3.

As shown in FIG. 1A, and by reference number 106, the acoustic sensor 102 may detect a combined acoustic signal. In some aspects, the combined acoustic signal may comprise one or more acoustic signals of interest, ocean background sounds, noise, and interference.

As shown by reference number 108, the acoustic sensor 102 may transmit a sensor sequence signal 110 to the signal extraction system 104. In some aspects, the sensor sequence signal 110 may comprise a sequence of data corresponding to the combined acoustic signal.

As shown in FIG. 1B, and by reference number 112, the signal extraction system 104 may extract a signal segment 114 from the sensor sequence signal 110. In some aspects, the signal segment 114 may be extracted based on a sliding window. In some aspects, the sliding window may define a window or range of input data (e.g., the sensor sequence signal 110) to be extracted by the signal extraction system 104. The window or range of input data may correspond to a size of the sliding window For example, a size of the sliding window may correspond to a time period (e.g., 1 second, 5 seconds, 10 seconds, or the like) or a quantity of data (e.g., 4 bits, 8 bits, 16 bits, or the like), among other examples. In some aspects, the signal extraction system 104 may extract a portion of the sensor sequence signal 110 that extends from a start of the sliding window to an end of the sliding window.

As an example, a size of the starting window may correspond to a time period (e.g., 2 seconds, as shown in FIG. 1B). Initially, a start of the sliding window may correspond to a first time (e.g., 0, as shown in FIG. 1B) and an end of the sliding window may correspond to a second time that is the time period (e.g., 2 seconds) later than the first time. The signal extraction system 104 may extract a signal segment 114 that corresponds to the portion of the combined signal detected by the acoustic sensor 102 during a time period that begins at the first time and ends at the second time.

As another example, the sensor sequence signal 110 may be represented by s(t). For a sliding window with a length (l) and at a position t=n*l, the extracted signal segment may be calculated by:

$$w ( t , i ) = \{ \begin{matrix}1 , & t \geq n * i and t < i * n + l \\ 0 , & Otherwise\end{matrix} , and$$

$${s}_{g} ( t , i ) = w ( t , i ) * s ( t ) i = 0 , 1 , 2 , 3 … ,$$

where i is the index of signal segments, n is the time-shifting length of the sliding window (e.g., the quantity of units that the sliding window moves forward), and l is the length of the sliding window.

In some aspects, after the signal segment 114 is extracted, the sliding window may move (e.g., slide) a quantity of units forward to enable the signal extraction system 104 to extract another signal segment in a similar manner. In some aspects, the quantity of units that the sliding window moves forward may be less than a size of the sliding window. For example, a size of the sliding window may be 10 seconds and the quantity of units that the sliding window moves forward may be less than 10 seconds (e.g., 1 second, 5 seconds, 9 seconds, or the like). Stated differently, a subsequently extracted signal segment may overlap with a previously extracted signal segment. In some aspects, the quantity of units that the sliding window moves forward may be less than a size of the sliding window to enable the signal extraction system 104 to report extracted acoustic signals at every time-position of the sliding window.

As shown in FIG. 1C, and by reference number 116, the signal extraction system 104 may convert the signal segment 114 into a signal spectrogram 118. The signal spectrogram 118 may be a time-frequency representation of the signal segment 114. In some aspects, the signal spectrogram 118 may be a two-dimensional array. A first dimension of the array may be a time dimension, and a second dimension of the array may be a frequency dimension.

In some aspects, the signal spectrogram 118 may include varying colors and/or varying shades of colors to represent different levels of power for each element in the two-dimensional spectrogram array. For example, as shown in FIG. 1C, different levels of power for each element in the two-dimensional spectrogram array may be represented utilizing a range of colors extending from black to white.

In some aspects, sensor sequence signal 110, and therefore, the signal segment 114 is in the time domain and the signal extraction system 104 uses a short time Fourier transformation (STFT) to convert the signal segment 114 into a signal spectrogram. For a signal x(t), the STFT of the signal may be defined by:

$$X ( τ , ω ) = {\int }_{- ∞}^{∞} x ( t ) w ( t - τ ) {e}^{- j ω t} d t ,$$

where w(t) is a window function that determines the frequency resolution of the STFT. For a discrete signal sequence (n), an STFT of the signal may be calculated as:

$$X ( m , ω ) = S T F T ( x ( n ) , m , ω ) = {\sum }_{n = - ∞}^{∞} x ( n ) w ( n - m ) {e}^{- i ω n} ,$$

where m is the time-shift, ω is frequency, and w(n−m) is a window function (e.g., a Hamming window function).

In some aspects, the spectrogram of the signal segment 114 may be calculated as:

spectrum(s_{g},m,ω)=|X(m,ω)|².

In some aspects, the spectrogram of the signal segment 114 may be calculated based on a log function. For example, the spectrogram of the signal segment 114 may be calculated as:

spectrum(s_{g}(n),m,ω)=20 log₁₀(|X(m,ω)|).

As shown in FIG. 1D, and by reference number 120, the signal extraction system 104 may insert a set of witness points 124 into the signal spectrogram 118 to generate a modified signal spectrogram 122. In some aspects, the signal extraction system 104 may insert the set of witness points 124 to monitor distortion that may be introduced during further processing of the signal spectrogram 118 (e.g., two-dimensional data shifting and ICA, described below).

In some aspects, the set of witness points 124 may comprise a two-dimensional patch of points inserted into a particular location or area of the signal spectrogram 118. For example, the set of witness points 124 may be a two-dimensional patch of points inserted into an upper-right corner, an upper-left corner, a lower-right corner, or a lower-left corner, among other examples, of the signal spectrogram 118. As shown in FIG. 1D, the set of witness points 124 are placed in an upper-left corner of the signal spectrogram 118 to generate the modified signal spectrogram 122.

In some aspects, the set of witness points 124 may be defined by a two-dimension impulse function. For example, the set of witness points (e.g., the two-dimensional patch of points) may be defined as:

$$wtns ( m , n ) = \{ \begin{matrix}{x}_{max} , & m = \frac{rows}{2} and n = \frac{cols}{2} \\ {x}_{min} , & otherwise\end{matrix} ,$$

where wtns(m, n) is a two-dimensional (rows×cols) set of witness points corresponding to the set of witness points 124, xₘᵢₙ is a minimal value of the signal spectrogram 118, xₘₐₓ is a maximal value of the signal spectrogram 118, rows is a quantity of rows of witness points (e.g., the quantity of rows of witness points included in the two-dimensional patch of points) and cols is a quantity of columns of witness points (e.g., the quantity of columns of witness points included in the two-dimensional patch of points).

In some aspects, based on performing two-dimensional data shifting and ICA, as described below, the impulse function (e.g., the set of witness points 124) may result in a point spread function at the location at which the set of witness points 124 are inserted into the signal spectrogram 118. In some aspects, the point spread function may be used in signal deconvolution for removing distortion introduced during the processing of the signal spectrogram 118.

As shown in FIG. 1E, and by reference number 126, the signal extraction system 104 may perform two-dimensional data shifting on the modified signal spectrogram 122 to generate multiple shifted signal spectrograms 128 from a single signal spectrogram (e.g., the signal spectrogram 118). By generating multiple shifted signal spectrograms 128, the signal extraction system 104 can perform a blind-source signal separation technique without requiring data obtained by multiple acoustic sensors located in different physical locations.

In some aspects, as shown in FIG. 1E, the signal extraction system 104 may include a two-dimensional data shifting component 132 that is configured to receive the modified signal spectrogram 122 and to perform two-dimensional data shifting on the modified signal spectrogram 122 to generate multiple shifted signal spectrograms 128 (e.g., shifted signal spectrograms 128A, 128B, and 128C, as shown in FIG. 1E). In some aspects, the set of witness points 124 may be shifted in a corresponding manner. For example, as shown in FIG. 1E, shifted signal spectrogram 128A may include a shifted set of witness points 124A, shifted signal spectrogram 128B may include a shifted set of witness points 124B, and shifted signal spectrogram 128C may include a shifted set of witness points 124C.

In some aspects, the two-dimensional data shifting may include a time shift and a frequency shift. In some aspects, the time shift and the frequency shift may be independently or separately performed. For example, a time shift may be applied to rows of the signal spectrogram 118 and a frequency shift may be applied to columns of the signal spectrogram 118.

In some aspects, a circular shift method is used to perform the time shift and/or the frequency shift. For example, a circular shifting of a sequence (x(n)) with a length (L), and a shifting of d units may be calculated by:

$${x}_{s hift} ( k ) = \{ \begin{matrix}x ( L - d + k ) , & k \leq d \\ x ( k - d ) , & otherwise\end{matrix} ; k = 1 , 2 , 3 , … L .$$

In some aspects, the time shift may be associated with a shift range (e.g., a range of values (e.g., shift values) corresponding to d in the equation described above). The time shift may be performed for each shift value within the shift range. The time shift performed for each shift value may generate a shifted signal spectrogram.

In some aspects, a shift range associated with performing the time shift may be different from a shift range associated with performing the frequency shift. For example, the shift range associated with performing the time shift may be larger than the shift range associated with performing the frequency shift. In some other aspects, the shift range associated with the time shift may be the same as the shift range associated with the frequency shift.

In some aspects, performing two-dimensional data shifting on the modified signal spectrogram 122 to generate multiple shifted signal spectrograms 128 may increase the energy of acoustic signals in the ICA based on shifted acoustic signals being correlated in the ICA process and based on noise being uncorrelated in an ICA process. For example, performing ICA on the multiple shifted signal spectrograms 128 may cause shifted acoustic signals to be correlated while shifted noise may be uncorrelated. In some aspects, the multiple shifted signal spectrograms 128 may increase the signal-to-noise ratio (SNR) in the ICA process.

As shown in FIG. 1F, and by reference number 130, the signal extraction system 104 may perform an ICA process based on the shifted signal spectrograms 128 to separate one or more signal components 132, including the shifted sets of witness points 124A, 124B, 124C, from noise 134. In some aspects, the signal extraction system 104 may receive the multiple shifted signal spectrograms as an input and perform an ICA process to generate an output indicating estimated signal sources (e.g., independent components) in the spectrogram domain.

In some aspects, the signal extraction system 104 may convert the shifted signal spectrograms 128 into an input data array and may perform the ICA process on the input data array. In some aspects, the signal extraction system 104 may convert the shifted signal spectrograms 128 into an input data array based on converting each shifted signal spectrogram 128 into a vector representation of the shifted signal spectrogram 128. For example, the signal extraction system 104 may concatenate each row of the shifted signal spectrogram 128A to generate a vector representation of the shifted signal spectrogram 128A. Similarly, the signal extraction system 104 may concatenate each row of the shifted signal spectrogram 128B to generate a vector representation of the shifted signal spectrogram 128B and may concatenate each row of the shifted signal spectrogram 128C to generate a vector representation of the shifted signal spectrogram 128C.

In some aspects, the signal extraction system 104 may generate the input data array based on the vector representations of the shifted signal spectrograms 128. For example, the signal extraction system 104 may generate an input data array having a first row corresponding to the vector representation of the shifted signal spectrogram 128A, a second row corresponding to the vector representation of the shifted signal spectrogram 128B, and a third row corresponding to the vector representation of the shifted signal spectrogram 128C.

In some aspects, the signal extraction system 104 may perform a data normalization process on the input data array. In some aspects, the data normalization process may enable mixed signals to be analyzed in the same dynamic range.

In some aspects, the data normalization process may be performed on columns of the input data array. For example, each column vector of the input data array may be normalized into a range of [0, 1] using the following equation:

$${col}_{n m} = \frac{col - min ( col )}{max ( col )} ,$$

where col is the column vector of the input data array.

In some aspects, the signal extraction system 104 may perform the ICA process based on normalizing the input data array. In some aspects, the ICA process may be a blind source separation technique for separating independent signals (e.g., independent components) from a set of mixtures of the independent signals. The ICA process may be based on an assumption that independent signals generated by separate, independent sources are non-Gaussian source signals and that mixed signals from the independent source signals are Gaussian signals according to the central limit theorem.

As an example, for independent source signals sᵢ(t), i=1, 2, 3, . . . . N and mixed signals xⱼ(t), j=1, 2, 3, . . . . M, a combined signal X(t) may be represented as:

X(t)=AS(t),

X(t)=[x₁(t), . . . x_{M}(t)]^{T}, and

S(t)=[s₁(t), . . . s_{N}(t)]^{T},
where A is an M×N mixing matric that determines how the independent source signals are mixed.

In some aspects, the ICA process is used to estimate the mixing matrix A from observed mixed signals. Based on the mixing matrix A, the independent source signals may be calculated by:

S(t)=WX(t),
where W=A⁻¹.

In some aspects, the mixing matrix A may be determined based on a maximization of non-Gaussianity, which is the assumed property of the independent source signals. In some aspects, the mixing matrix A may be determined based on a minimization of mutual information. Because the independent source signals are independent, information included in one independent source signal is not included in any of the other independent source signals.

In some aspects, the signal extraction system 104 may determine the mixing matrix A based on a joint approximation diagonalization of eigen-matrices ICA technique (referred to herein as “JADE”). In some aspects, JADE may determine the mixing matrix A based on the maximization of non-Gaussianity. As an example, for an input data array (X) obtained from one shifted signal spectrogram 128, a mixing matrix A may be determined by:

A=JADE(X,num_ind),
where X=[x₁, . . . xₘ]^{T}, xᵢ=[xᵢ₁, . . . xᵢₙ], and num_ind is a predefined number of independent source signals. The independent source signals(S) may be determined by:

S=A⁻¹X.
In some aspects, each row of the matrix S, may be an estimated independent source signal (e.g., an independent component).

In some aspects, the signal extraction system 104 may convert the one or more independent components 140 into a two-dimensional signal spectrogram. For example, the signal extraction system 104 may convert each estimated independent source signal into respective two-dimensional signal spectrogram.

As shown in FIG. 1G, and by reference number 136, the signal extraction system 104 may select one or more independent components 140 from the signal components 132. In some aspects, the signal extraction system 104 may select the one or more independent components 140 based on the one or more independent components 140 being associated with a potential signal of interest.

In some aspects, the signal extraction system 104 may utilize a peak SNR (PSNR) based method to select the one or more independent components 140. In some aspects, the PSNR may measure signal energy and may be used for independent components 140 having non-tone signals. As an example, for an independent component (IC(i, j)), the PSNR may be estimated by:

PSNR=max(IC)/mean(IC).
The signal extraction system 104 may select the one or more independent components 140 based on the PSNR estimated for each independent component 140.

In some aspects, the signal extraction system 104 may select the independent component 140 associated with a maximal PSNR relative to the PSNRs calculated for the other independent components 140. In some aspects, the signal extraction system 104 may select each independent component 140 associated with a PSNR that satisfies (e.g., is greater than) a threshold.

In some aspects, a linear score based method may be used to select the one or more independent components 140. The linear score based method may calculate a linear score based on linear patterns in the one or more independent components 140. In some aspects, the linear score based method may be utilized for independent components 140 having tone signals.

In some aspects, edge maps for the one or more independent components 140 may be generated based on applying a vertical edge (e.g., frequency axis) detection to the one or more independent components 140. In some aspects, the vertical edge detection may be a Sobel detector.

In some aspects, a linear mask having a linear length may be used to compute correlations with the one or more independent components 140. In some aspects, the linear length of the linear mask may threshold correlation values corresponding to the computed correlations. For example, the linear length of the linear mask may prevent correlation values corresponding to the computed correlations from exceeding a threshold (e.g., a threshold corresponding to the linear length). In some aspects, the signal extraction system 104 may determine the linear score based on a sum of the correlation values.

As an example, an independent component 140 may have rows corresponding to a time index and columns corresponding to frequencies. An edge map (Eg) for the independent component 140 may be calculated by:

Eg=Sobel(IC,‘vertical’).
In some aspects, the correlation (e.g., convolution) of edge maps calculated for the one or more independent components 140 with a vertical linear mask may be computed by:

Cor=conv(Eg,mask_{L}),
where mask_{L} is a vertical mask with a linear length of L.

In some aspects, the correlation thresholding may be calculated by:

$${Cor}_{c h} ( i , j ) = \{ \begin{matrix}Cor ( i , j ) , & if Cor ( i , j ) \geq L \\ 0 , & otherwise\end{matrix} .$$

The linear score may be computed by:

Score_linear=Σ_{i,j}Corₜₕ(i,j)/num_colums_in_IC.

In some aspects, the signal extraction system 104 may select the independent component 140 associated with a maximal linear score relative to the linear scores calculated for the other independent components 140. In some aspects, the signal extraction system 104 may select each independent component 140 associated with a linear score that satisfies (e.g., is greater than) a threshold.

As shown by reference number 138, the signal extraction system 104 may perform a deconvolution process. In some aspects, a deconvolution component 142 of the signal extraction system 104 may perform a deconvolution process using a point spread function generated by the sets of witness points 124 to compensate for distortions introduced by the time-frequency data shifting and the ICA processes. In some aspects, the deconvolution process may be a Richardson-Lucy (R-L) restoration algorithm.

In some aspects, the signal spectrogram may be modeled as:

g=h⊗s+n,
where g is the distorted signal spectrogram, s is the original undistorted signal spectrogram, h is the point spread function of the system, n is noise, and the operator ⊗ is the convolution operator.

In some aspects, the R-L algorithm may provide a solution of iteratively estimating the signal spectrogram(s) as follows:
At the kth iteration, the estimated signal spectrogram (sₖ) may be obtained based on the following equations:

$${s}_{k} = {x}_{k} + {α}_{k} {d}_{k} ,$$

$${x}_{k} = {s}_{k - 1} + {r}_{k - 1} ,$$

$${r}_{k - 1} = Ψ ( {s}_{k - 1} ) - {s}_{k - 1} ,$$

$$Ψ ( {s}_{k - 1} ) = {s}_{k - 1} ( h * \frac{g}{h ⊗ {s}_{k - 1}} ) ,$$

$${d}_{k} = {x}_{k} - {x}_{k - 1} ,$$

$${α}_{k} = \frac{\sum {r}_{k - 1} {r}_{k - 2}}{\sum {r}_{k - 2} {r}_{k - 2}} ,$$

Where * is a correlation operator, sₖ is the predicted signal spectrogram at iteration k, xₖ is the iterated image, dₖ is the predicted direction, and ψ(s) is the R-L restoration algorithm. In some aspects, for each selected independent component 140, the signal extraction system 104 may obtain the point spread function corresponding to the shifted witness points 124 at the location at which the set of witness points 124 are inserted. In some aspects, the signal extraction system 104 may apply the R-L restoration algorithm to the selected independent component 140 based on the point spread function to remove distortion introduced by the time-frequency data shifting and ICA processes.

As shown in FIG. 1H, and by reference number 144, the signal extraction system 104 may enhance the one or more selected independent components 140 (e.g., the signal of interest) to generate one or more enhanced signals 146. In some aspects, the signal extraction system 104 may perform one or more processes to reduce noise and/or enhance a selected independent component 140 (e.g., to enhance the signal of interest).

In some aspects, the signal extraction system 104 may reduce background noise by thresholding the signal spectrogram (e.g., the selected independent component 140). In some aspects, the denoised independent component 140 may be determined using the following equation:

$${IC}_{d n} ( i , j ) = \{ \begin{matrix}IC ( i , j ) , & if IC ( i , j ) \geq thre * mean ( IC ) \\ min ( IC ) , & otherwise\end{matrix} ,$$

where thre is a predefined threshold level. In some aspects, utilizing the signal-size filter may increase or enlarge the difference between signal values and background noise.

In some aspects, the signal extraction system 104 may utilize a signal-size filter to reduce noise in the independent component 140. For example, the signal-size filter may comprise a filter that is configured to remove small data clusters based on a likelihood or probability that the small data clusters correspond to noise clusters. In some aspects, the signal extraction system 104 may fill holes in the input data prior to filtering a selected independent component. In some aspects, the holes may comprise single points of data or pixels having a value of zero that are surrounded by points of data having non-zero values. In some aspects, the holes in the input data (x) may be filled in based on the following equation:

$$x ( i , j ) = \{ \begin{matrix}mean ( {x}_{ij - nb} ) , & if x ( i , j ) = 0 and {x}_{ij - nb} \neq 0 \\ x ( i , j ) , & otherwise\end{matrix} ,$$

where x_{ij-nb} is a set of neighboring points of x(i, j).

In some aspects, the signal extraction system 104 may cluster the input data (x) based on filling in the holes in the input data. In some aspects, the signal extraction system 104 may utilize the signal-size filter to filter the clustered input data. In some aspects, the signal-size filter may be defined as:

$${x}_{ssf} ( i , j ) = \{ \begin{matrix}0 , & if size ( cluster ( i , j ) ) < sz \\ x ( i , j ) , & otherwise\end{matrix} ,$$

where cluster (i, j) is the data cluster that contains x(i, j). In some aspects, the signal-size filter may apply a signal size constraint to the signal extraction process (e.g., the signal-size filter may cause the extracted signal to have a minimal size corresponding to the size of the signal-size filter).

As shown in FIG. 1I, and by reference number 148, the signal extraction system 104 may extract the acoustic signal 150 from the enhanced signal. In some aspects, the acoustic signal may be a tone signal. In these aspects, the extracted acoustic signal 150 may correspond to a single column of the selected independent component 140 with rows for a time index and columns for frequency. In some aspects, the acoustic signal may be a non-tone signal. In these aspects, the extracted acoustic signal 150 may correspond to multiple columns of the selected independent component 140.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

FIG. 2 is a diagram of an example environment 200 in which systems and/or methods described herein may be implemented. As shown in FIG. 2, environment 200 may include an acoustic sensor 102 and a signal extraction system 104. Devices of environment 200 may interconnect via wired connections, wireless connections, or a combination of wired and wireless connections.

The acoustic sensor 102 may include one or more devices capable of detecting an acoustic signal. For example, the acoustic sensor 102 may comprise one or more devices capable of detecting and recording acoustic waves by converting acoustic energy into electrical signals. In some aspects, the acoustic sensor 102 may include a hydrophone configured to detect underwater acoustic signals (e.g., underwater sound waves). Additionally, or alternatively, the acoustic sensor 102 may include one or more other types of acoustic sensors such as a microphone, a vector sensor, a piezoelectric transducer, an ultrasonic sensor, and/or an acoustic emission sensor, among other examples.

The signal extraction system 104 may include one or more devices capable of receiving, generating, storing, processing, and/or providing information associated with acoustic signal extraction, as described elsewhere herein. The signal extraction system 104 may include a communication device and/or a computing device. For example, the signal extraction system 104 may include a wireless communication device, a user equipment, a laptop computer, a tablet computer, a desktop computer, or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with acoustic signal extraction. The device 300 may correspond to an acoustic sensor 102 and/or an signal extraction system 104. In some implementations, the acoustic sensor 102 and/or the signal extraction system 104 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

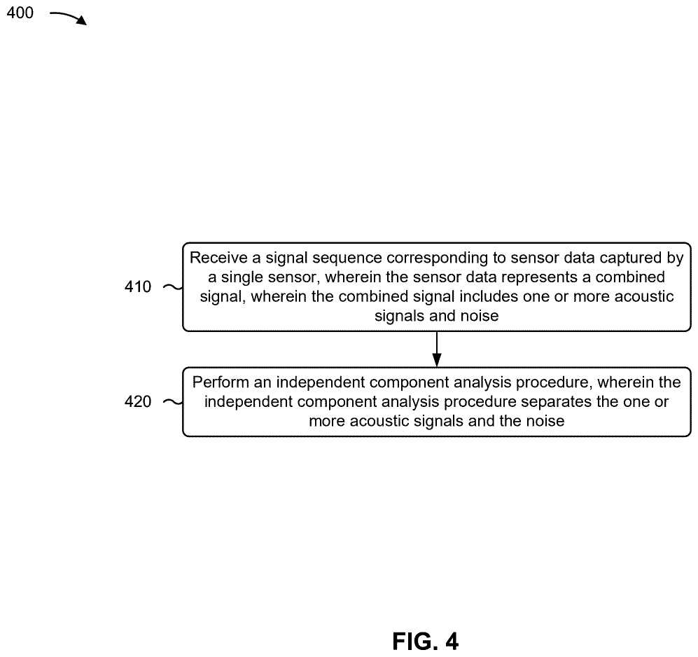

FIG. 4 is a flowchart of an example process 400 associated with acoustic signal extraction. In some implementations, one or more process blocks of FIG. 4 are performed by a signal extraction system (e.g., signal extraction system 104). In some implementations, one or more process blocks of FIG. 4 are performed by another device or a group of devices separate from or including the signal extraction system, such as an acoustic sensor (e.g., acoustic sensor 102). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving a signal sequence corresponding to sensor data captured by a single sensor, wherein the sensor data represents a combined signal, wherein the combined signal includes one or more acoustic signals and noise (block 410). For example, the signal extraction system may receive a signal sequence corresponding to sensor data captured by a single sensor, wherein the sensor data represents a combined signal, wherein the combined signal includes one or more acoustic signals and noise, as described above.

As further shown in FIG. 4, process 400 may include performing an independent component analysis procedure, wherein the independent component analysis procedure separates the one or more acoustic signals and the noise (block 420). For example, the signal extraction system may perform an independent component analysis procedure, wherein the independent component analysis procedure separates the one or more acoustic signals and the noise, as described above.

Process 400 may include additional implementations, such as any single implementation or any combination of implementations described below and/or in connection with one or more other processes described elsewhere herein.

In a first implementation, process 400 includes extracting a signal segment from the signal sequence based on a sliding window, wherein the independent component analysis procedure is performed on the signal segment.

In a second implementation, process 400 includes computing a signal spectrogram based on a segment of the signal sequence, and generating multiple spectrogram images based on the signal spectrogram, wherein the independent component analysis procedure is performed based on the multiple spectrogram images.

In a third implementation, generating the multiple spectrogram images comprises inserting witness points into the signal spectrogram, and performing time-frequency shifting to generate the multiple spectrogram images based on a pre-defined shifting range with the inserted witness points in the signal spectrogram.

In a fourth implementation, process 400 includes selecting one or more independent components from the group of independent components based on the independent component containing potential signals of interest, performing signal deconvolution on the selected independent components based on the point spread function generated by the witness points and a deconvolution technique, and extracting the signals of interest based on performing the signal deconvolution.

In a fifth implementation, process 400 includes enhancing weak signals in the spectrogram domain, wherein the potential signals of interest are extracted in the spectrogram domain and based on enhancing the signals in the spectrogram domain.

In a sixth implementation, performing the independent component analysis procedure comprises generating an input data array based on the multiple spectrogram images, performing data normalization on the input data array to generate a normalized input data array, estimating a mixing matrix with an independent component analysis technique based on the normalized input data array, computing an independent component matrix based on the mixing matrix, estimating a set of independent components based on the independent component matrix, and converting the estimated set of independent components to respective spectrogram images.

In a seventh implementation, generating the input data array comprises converting each spectrogram image, of the multiple spectrogram images, into a respective vector.

In an eighth implementation, converting each spectrogram image into the respective vectors comprises for each spectrogram image, concatenating each row of the spectrogram image.

In a ninth implementation, a quantity of independent components included in the set of independent components is based on a predefined quantity of independent signal sources.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

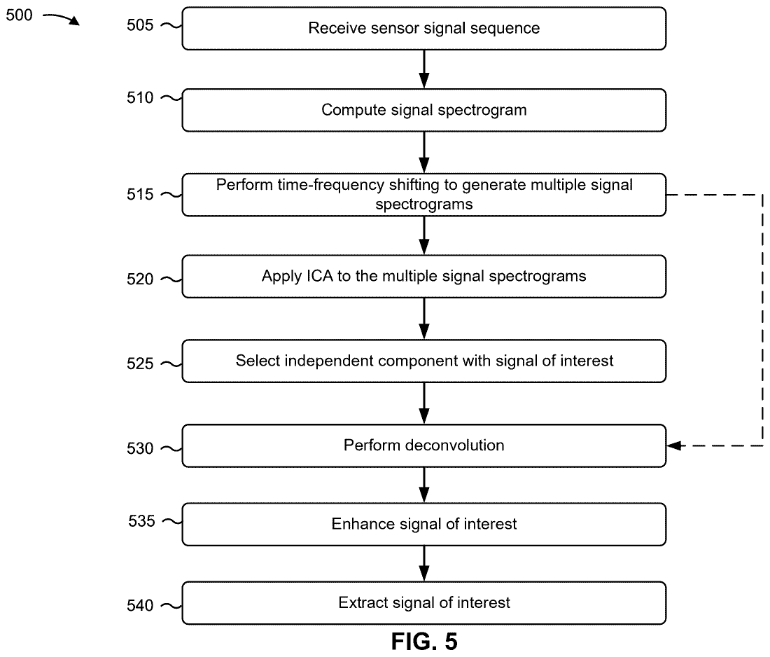

FIG. 5 is a flowchart of an example process 500 associated with acoustic signal extraction. In some implementations, one or more process blocks of FIG. 5 are performed by a signal extraction system (e.g., signal extraction system 104). In some implementations, one or more process blocks of FIG. 5 are performed by another device or a group of devices separate from or including the signal extraction system, such as an acoustic sensor (e.g., acoustic sensor 102). Additionally, or alternatively, one or more process blocks of FIG. 5 may be performed by one or more components of device 300, such as processor 320, memory 330, input component 340, output component 350, and/or communication component 360.

As shown in FIG. 5, process 500 may include receiving a signal sequence (block 505). For example, the signal extraction system may receive a signal sequence, as described above.

As further shown in FIG. 5, process 500 may include computing a signal spectrogram (block 510). For example, the signal extraction system may compute a signal spectrogram, as described above.

As further shown in FIG. 5, process 500 may include performing time-frequency shifting to generate multiple signal spectrograms (block 515). For example, the signal extraction system may perform time-frequency shifting to generate multiple signal spectrograms, as described above.

As further shown in FIG. 5, process 500 may include applying ICA to the multiple signal spectrograms (block 520). For example, the signal extraction system may apply ICA to the multiple signal spectrograms, as described above.

As further shown in FIG. 5, process 500 may include selecting independent components with a signal of interest (block 525). For example, the signal extraction system may select independent components with a signal of interest, as described above.

As further shown in FIG. 5, process 500 may include performing deconvolution (block 530). For example, the signal extraction system may perform deconvolution, as described above. As indicated in FIG. 5 by a dashed arrow, in some aspects, the deconvolution is performed based on a time-frequency shifting pattern utilized to perform the time-frequency shifting. For example, the time-frequency shifting pattern may indicate a series of shifts that were performed to generate the multiple signal spectrograms and the deconvolution may be performed based on a reversal of the series of shifts.

As further shown in FIG. 5, process 500 may include enhancing the signal of interest (block 535). For example, the signal extraction system may enhance the signal of interest, as described above.

As further shown in FIG. 5, process 500 may include extracting the signal of interest (block 540). For example, the signal extraction system may extract the signal of interest, as described above.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

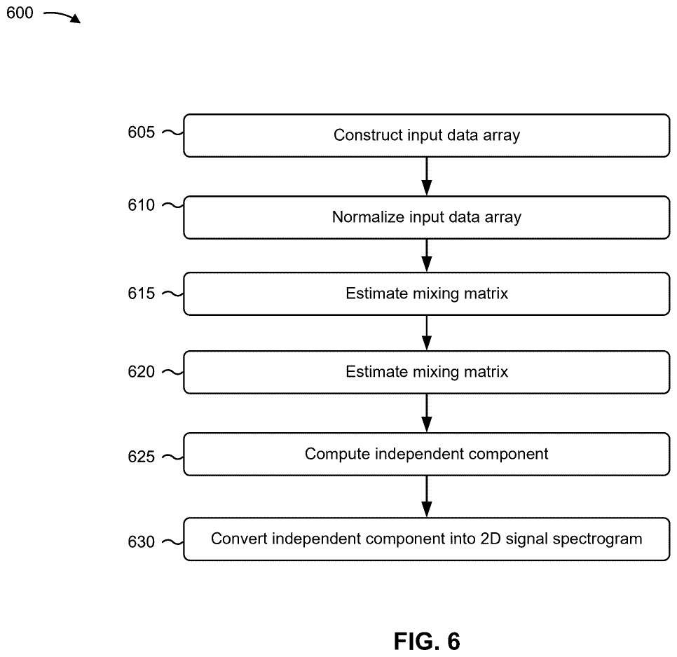

FIG. 6 is a flowchart of an example process 600 associated with performing an ICA. In some implementations, one or more process blocks of FIG. 6 are performed by a signal extraction system (e.g., signal extraction system 104). In some implementations, one or more process blocks of FIG. 6 are performed by another device or a group of devices separate from or including the signal extraction system. Additionally, or alternatively, one or more process blocks of FIG. 6 may be performed by one or more components of device 300, such as processor 320, memory 330, input component 340, output component 350, and/or communication component 360.

As shown in FIG. 6, process 600 may include constructing an input data array (block 605). For example, the signal extraction system may construct an input data array, as described above.

As further shown in FIG. 6, process 600 may include normalizing the input data array (block 610). For example, the signal extraction system may normalize the input data array, as described above.

As further shown in FIG. 6, process 600 may include converting the input data array into one-dimensional vectors for estimating the mixing matrix. For example, the input data array may be a two-dimensional data array and the signal extraction system may convert the two-dimensional data array into a set of one-dimensional vectors that can be used to estimate the mixing matrix using an independent component analysis.

As further shown in FIG. 6, process 600 may include estimating the mixing matrix (block 615). For example, the signal extraction system may estimate the mixing matrix, as described above.

As further shown in FIG. 6, process 600 may include computing the independent components (block 620). For example, the signal extraction system may compute the independent components, as described above.

As further shown in FIG. 6, process 600 may include converting the independent components into two-dimensional signal spectrograms (block 625). For example, the signal extraction system may convert the independent components into two-dimensional signal spectrograms, as described above.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:

Aspect 1: A method, comprising: receiving a signal sequence corresponding to sensor data captured by a single sensor, the sensor data representing a combined signal, the combined signal including one or more acoustic signals and noise; and performing an independent component analysis procedure, the independent component analysis procedure separating the one or more acoustic signals and the noise.

Aspect 2: The method of Aspect 1, further comprising: extracting a signal segment from the signal sequence based on a sliding window, the independent component analysis procedure being performed on the signal segment.

Aspect 3: The method of any of Aspects 1-2, further comprising: computing a signal spectrogram based on a segment of the signal sequence; and generating multiple spectrogram images based on the signal spectrogram, the independent component analysis procedure being performed based on the multiple spectrogram images.

Aspect 4: The method of Aspect 3, wherein generating the multiple spectrogram images comprises: inserting witness points into the signal spectrogram; and performing time-frequency shifting to generate the multiple spectrogram images based on a pre-defined shifting range with the inserted witness points in the signal spectrogram.

Aspect 5: The method of Aspect 4, further comprising: selecting one or more independent components from the group of independent components based on the independent component containing potential signals of interest; performing signal deconvolution on the selected independent components based on the point spread function generated by the witness points and a deconvolution technique; and extracting the signals of interest based on performing the signal deconvolution.

Aspect 6: The method of Aspect 5, further comprising: enhancing weak signals in the spectrogram domain, the potential signals of interest being extracted in the spectrogram domain and based on enhancing the signals in the spectrogram domain.

Aspect 7: The method of Aspect 6, wherein performing the independent component analysis procedure comprises: generating an input data array based on the multiple spectrogram images; performing data normalization on the input data array to generate a normalized input data array; estimating a mixing matrix with an independent component analysis technique based on the normalized input data array; computing an independent component matrix based on the mixing matrix; estimating a set of independent components based on the independent component matrix; and converting the estimated set of independent components into respective spectrogram images.

Aspect 8: The method of Aspect 7, wherein generating the input data array comprises: converting each spectrogram image, of the multiple spectrogram images, into a respective vector.

Aspect 9: The method of Aspect 7, wherein converting each spectrogram image into the respective vectors comprises: for each spectrogram image, concatenating each row of the spectrogram image.

Aspect 10: The method of Aspect 7, wherein a quantity of independent components included in the set of independent components is based on a predefined quantity of independent signal sources.

Aspect 11: A system, comprising: one or more memories; and one or more processors, coupled to the one or more memories, configured to: receive a signal sequence corresponding to sensor data captured by a single sensor, wherein the sensor data represents a combined signal, the combined signal including one or more acoustic signals and noise; and perform an independent component analysis procedure to separate the one or more acoustic signals and the noise.

Aspect 12: The system of Aspect 11, wherein the one or more processors are further configured to: extract a signal segment from the signal sequence based on a sliding window, the independent component analysis procedure being performed on the signal segment.

Aspect 13: The system of any of Aspects 11-12, wherein the one or more processors are further configured to: compute a signal spectrogram based on a segment of the signal sequence; and generate multiple spectrogram images based on the signal spectrogram, the independent component analysis procedure being performed based on the multiple spectrogram images.

Aspect 14: The system of Aspect 13, wherein the one or more processors, to generate the multiple spectrogram images, are configured to: insert witness points into the signal spectrogram; and perform time-frequency shifting to generate the multiple spectrogram images based on a pre-defined shifting range with the inserted witness points in the signal spectrogram.

Aspect 15: The system of Aspect 14, wherein the one or more processors are further configured to: select one or more independent components from the group of independent components based on the independent component containing potential signals of interest; perform signal deconvolution on the selected independent components based on a point spread function generated by the witness points and a deconvolution technique; and extract the signals of interest based on performing the signal deconvolution.

Aspect 16: The system of Aspect 15, wherein the one or more processors are further configured to: enhance the signal of interest in a spectrogram domain, the signal of interest being extracted in the spectrogram domain and based on enhancing the signal of interest in the spectrogram domain.

Aspect 17: A non-transitory computer-readable medium storing a set of instructions, the set of instructions comprising: one or more instructions that, when executed by one or more processors of a system, cause the system to: receive a signal sequence corresponding to sensor data captured by a single sensor, the sensor data representing a combined signal, the combined signal including one or more acoustic signals and noise; and perform an independent component analysis procedure to separate the one or more acoustic signals and the noise.

Aspect 18: The non-transitory computer-readable medium of Aspect 17, wherein the one or more instructions further cause the system to: extract a signal segment from the signal sequence based on a sliding window, the independent component analysis procedure being performed on the signal segment.

Aspect 19: The non-transitory computer-readable medium of Aspect 18, wherein the one or more instructions further cause the system to: compute a signal spectrogram based on a segment of the signal sequence; and generate multiple spectrogram images based on the signal spectrogram, the independent component analysis procedure being performed based on the multiple spectrogram images.

Aspect 20: The non-transitory computer-readable medium of Aspect 19, wherein the one or more instructions, that cause the system to generate the multiple spectrogram images, cause the system to: insert witness points into the signal spectrogram; and perform time-frequency shifting to generate the multiple spectrogram images based on a pre-defined shifting range with the inserted witness points in the signal spectrogram.

Aspect 21: An apparatus comprising means for performing one or more operations recited in one or more of Aspects 1-20.

Aspect 22: A computer program product comprising instructions or code for executing one or more operations recited in one or more of Aspects 1-20.

The foregoing disclosure provides illustration and description, but is not intended to be exhaustive or to limit the implementations described herein to the precise forms that are described. Modifications and variations may be made in light of the above description or may be acquired from practice of the implementations described herein.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations described herein. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in the specification, these combinations are not intended to limit the implementations described herein. In fact, many of these features may be combined in ways not specifically recited in the claims and/or described in the specification. Although each dependent claim listed below may directly depend on only one claim, the description includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving a signal sequence corresponding to sensor data captured by a single sensor, wherein the sensor data represents a combined signal, wherein the combined signal includes one or more acoustic signals and noise; and
performing an independent component analysis procedure, wherein the independent component analysis procedure separates the one or more acoustic signals and the noise.

2. The method of claim 1, further comprising:
extracting a signal segment from the signal sequence based on a sliding window,
wherein the independent component analysis procedure is performed on the signal segment.

3. The method of claim 1, further comprising:
computing a signal spectrogram based on a segment of the signal sequence; and
generating multiple spectrogram images based on the signal spectrogram, wherein the independent component analysis procedure is performed based on the multiple spectrogram images.

4. The method of claim 3, wherein generating the multiple spectrogram images comprises:
inserting witness points into the signal spectrogram; and
performing time-frequency shifting to generate the multiple spectrogram images based on a pre-defined shifting range with the inserted witness points in the signal spectrogram.

5. The method of claim 4, further comprising:
selecting one or more independent components from a group of independent components based on the one or more independent components containing potential signals of interest;
performing signal deconvolution on the selected one or more independent components based on a point spread function generated by the witness points and a deconvolution technique; and
extracting one or more signals of interest, of the potential signals of interest, based on performing the deconvolution technique.

6. The method of claim 5, further comprising:
enhancing weak signals in a spectrogram domain, wherein the one or more signals of interest are extracted in the spectrogram domain and based on enhancing the weak signals in the spectrogram domain.

7. The method of claim 6, wherein performing the independent component analysis procedure comprises:
generating an input data array based on the multiple spectrogram images;
performing data normalization on the input data array to generate a normalized input data array;
estimating a mixing matrix with an independent component analysis technique based on the normalized input data array;
computing an independent component matrix based on the mixing matrix;
estimating a set of independent components based on the independent component matrix; and
converting the estimated set of independent components into respective spectrogram images.

8. The method of claim 7, wherein generating the input data array comprises:
converting each spectrogram image, of the multiple spectrogram images, into a respective vector.

9. The method of claim 8, wherein converting each spectrogram image into the respective vector comprises:
for each spectrogram image, concatenating each row of the spectrogram image.

10. The method of claim 7, wherein a quantity of independent components included in the set of independent components is based on a predefined quantity of independent signal sources.

11. A system, comprising:
one or more memories; and
one or more processors, coupled to the one or more memories, configured to:
receive a signal sequence corresponding to sensor data captured by a single sensor, wherein the sensor data represents a combined signal, wherein the combined signal includes one or more acoustic signals and noise; and
perform an independent component analysis procedure to separate the one or more acoustic signals and the noise.

12. The system of claim 11, wherein the one or more processors are further configured to:
extract a signal segment from the signal sequence based on a sliding window,
wherein the independent component analysis procedure is performed on the signal segment.

13. The system of claim 11, wherein the one or more processors are further configured to:
compute a signal spectrogram based on a segment of the signal sequence; and
generate multiple spectrogram images based on the signal spectrogram, wherein the independent component analysis procedure is performed based on the multiple spectrogram images.

14. The system of claim 13, wherein the one or more processors, to generate the multiple spectrogram images, are configured to:
insert witness points into the signal spectrogram; and
perform time-frequency shifting to generate the multiple spectrogram images based on a pre-defined shifting range with the inserted witness points in the signal spectrogram.

15. The system of claim 14, wherein the one or more processors are further configured to:
select one or more independent components from a group of independent components based on the one or more independent components containing potential signals of interest;
perform signal deconvolution on the selected one or more independent components based on a point spread function generated by the witness points and a deconvolution technique; and
extract one or more signals of interest, of the potential signals of interest, based on performing the deconvolution technique.

16. The system of claim 15, wherein the one or more processors are further configured to:
enhance the one or more signals of interest in a spectrogram domain, wherein the one or more signals of interest are extracted in the spectrogram domain and based on enhancing the one or more signals of interest in the spectrogram domain.

17. A non-transitory computer-readable medium storing a set of instructions, the set of instructions comprising:
one or more instructions that, when executed by one or more processors of a system, cause the system to:
receive a signal sequence corresponding to sensor data captured by a single sensor, wherein the sensor data represents a combined signal, wherein the combined signal includes one or more acoustic signals and noise; and
perform an independent component analysis procedure to separate the one or more acoustic signals and the noise.

18. The non-transitory computer-readable medium of claim 17, wherein the one or more instructions further cause the system to:
extract a signal segment from the signal sequence based on a sliding window,
wherein the independent component analysis procedure is performed on the signal segment.

19. The non-transitory computer-readable medium of claim 18, wherein the one or more instructions further cause the system to:
compute a signal spectrogram based on a segment of the signal sequence; and
generate multiple spectrogram images based on the signal spectrogram, wherein the independent component analysis procedure is performed based on the multiple spectrogram images.

20. The non-transitory computer-readable medium of claim 19, wherein the one or more instructions, that cause the system to generate the multiple spectrogram images, cause the system to:
insert witness points into the signal spectrogram; and
perform time-frequency shifting to generate the multiple spectrogram images based on a pre-defined shifting range with the inserted witness points in the signal spectrogram.
